(19) United States
(12) Patent Application Publication
(10) Pub. No.: US 2020/0392781 A1
(43) Pub. Date: Dec. 17, 2020

(54) GAS FILLING OF AN INSULATING GLASS UNIT

(71) Applicant: PDS IG Holding LLC, Prairie Du Sac, WI (US)

(72) Inventor: Paul Trpkovski, Kailua Kona, HI (US)

(21) Appl. No.: 16/867,381

(22) Filed: May 5, 2020

Related U.S. Application Data
(62) Division of application No. 15/398,459, filed on Jan. 4, 2017, now abandoned.
(60) Provisional application No. 62/274,676, filed on Jan. 4, 2016.

(51) Int. Cl. E06B 3/677; E06B 3/66; E06B 3/673

(52) U.S. Cl. CPC E06B 3/6775; E06B 3/67365; E06B 3/67326; E06B 3/6612

(57) ABSTRACT

Embodiments include a method for replacing air with an interpane gas during manufacture of a sealed insulating glass unit (IGU). The method includes forming an unsealed IGU assembly defining an IGU passage for fluid communication between an interpane space and an ambient environment; positioning the unsealed IGU assembly within an enclosure and sealing the enclosure around the unsealed IGU assembly; evacuating air from the enclosure; introducing a first gas into the interpane space through the IGU passage; introducing a second gas into the enclosure, wherein the second gas has a different composition than the first gas; and closing the IGU passage to seal the interpane space. Other embodiments are also included herein.

This application is a Divisional of U.S. patent application Ser. No. 15/398,459, filed Jan. 4, 2017, which claims the benefit of U.S. Provisional Application No. 62/274,676, filed Jan. 4, 2016, the content of which is herein incorporated by reference in its entirety.

### FIELD OF THE TECHNOLOGY

The present application relates to filling an insulating glass unit. More specifically, the present application relates to filling an insulating glass unit with a gas within an enclosure.

### BACKGROUND

In recent years, there has been an increased awareness on energy usage and conservation. As a result many governing bodies have released energy standards and regulations for buildings and construction materials. These standards and regulations frequently require more energy efficient systems and components.

One specific area of focus includes more efficient windows and doors. Many governing bodies have passed regulations that require windows and doors to have a minimum insulating value to limit the amount of energy lost through windows and doors. As a result, window and door manufactures have needed to find ways to increase the insulating properties of their products. The materials and techniques used to produce more insulated windows and doors have resulted in an increased cost to manufacture the windows and doors.

Some techniques and systems have been developed to fill glass units with one or more insulating gases. For example, U.S. Pat. No. 8,627,856 discloses a method and apparatus wherein the insulating gases are supplied to gas filling tubes that are inserted into one or more interpane spaces of the insulating glass units. Each interpane space may be filled with more than one insulating gas. A control unit controls the injection of the insulating gases in accordance with gas filling data received by the control unit.

### SUMMARY

Embodiments disclosed herein include a method for replacing air with an interpane gas during manufacture of a sealed insulating glass unit (IGU) is described herein. A sealed IGU comprises first and second sheets of glass material and a spacer structure formed into a spacer frame between the first and second sheets and sealed to the first and second sheets. The sealed IGU defines an interpane space filled with an interpane gas. The method comprises the steps of: forming an unsealed IGU assembly defining an IGU passage for fluid communication between an interpane space and an ambient environment; positioning the unsealed IGU assembly within an enclosure and sealing the enclosure around the unsealed IGU assembly; evacuating air from the enclosure; introducing a first gas into the interpane space through the IGU passage; introducing a second gas into the enclosure, wherein the second gas has a different composition than the first gas; and closing the IGU passage to seal the interpane space.

In an embodiment, the step of forming an unsealed IGU assembly comprises sealing the spacer frame to the first sheet; and positioning a lower edge of the second sheet a distance away from the spacer structure to provide a bottom gap, wherein the bottom gap is the IGU passage permitting fluid communication with the interpane space.

In an embodiment, the step of introducing a first gas into the interpane space comprises positioning the IGU passage over a source of the first gas.

In an embodiment, a support structure supports the unsealed IGU assembly and defines a support passage for fluid communication between the source of the first gas and the IGU passage.

In an embodiment, the support structure comprises a conveyor belt. In an embodiment, the step of introducing the first gas into the interpane space overlaps in time with the step of introducing a second gas into the enclosure.

In an embodiment, a beginning of the step of introducing the first gas into the interpane space occurs within two seconds of a beginning of the step of introducing a second gas into the enclosure.

In an embodiment, a beginning of the step of introducing the first gas into the interpane space occurs simultaneously with a beginning of the step of introducing a second gas into the enclosure.

In an embodiment, the step of introducing a first gas into the interpane space comprises inserting a probe into the IGU passage.

In an embodiment, the probe comprises a low-friction coating or treatment.

In an embodiment, the step of forming an unsealed IGU assembly comprises sealing the spacer frame to the first sheet and second sheet; and creating an opening in the spacer frame to permit fluid communication with the interpane space.

In an embodiment, the step of forming an unsealed IGU assembly comprises sealing the spacer frame to the first sheet and second sheet; and creating an opening in the first or second sheet to permit fluid communication with the interpane space.

In an embodiment, the step of introducing the first gas into the interpane space occurs at a first pressure and the step of introducing the second gas into the enclosure occurs at a second pressure which is lower than the first pressure.

In an embodiment, the first gas is krypton.

In an embodiment, the second gas is argon.

In an embodiment, the second gas is air.

In an embodiment, the step of evacuating air from the enclosure comprises reducing the absolute pressure in the enclosure about 0.1 pounds per square inch (psi).

In an embodiment, the step of introducing the first gas into the interpane space occurs at an absolute pressure of about 14 psi.

A system is described herein for replacing air with an interpane gas during manufacture of a sealed insulating glass unit (IGU). A sealed IGU comprises first and second sheets of glass material and a spacer structure formed into a spacer frame between the first and second sheets and sealed to the first and second sheets. The sealed IGU defines an interpane space filled with an interpane gas. The system comprises an enclosure configured to enclose one or more unsealed IGUs; a vacuum source configured to evacuate an existing gas from the enclosure; a source of a first gas configured to introduce a first gas into the interpane space through an IGU passage for fluid communication; a source of a second gas configured to introduce a second gas into the enclosure; and a sealing device configured to seal the one or more unsealed IGUs, wherein sealing the one or more unsealed IGUs comprises closing the IGU passage.

In an embodiment, the source of the first gas is configured to be positioned below the IGU passage.

In an embodiment, the spacer frame is sealed to the first sheet, and wherein the IGU passage comprises a bottom gap between the spacer structure and a lower edge of the second sheet that is a distance away from the spacer structure.

In an embodiment, the system further comprises a support structure that is configured to support the unsealed IGU assembly, wherein the support structure defines a support passage for fluid communication between the source of the first gas and the IGU passage.

In an embodiment, the support structure comprises a conveyor belt.

In an embodiment, the source of the first gas is configured to introduce the first gas into the interpane space at a time overlapping in time with the source of the second gas introducing the second gas into the enclosure.

In an embodiment, the source of the first gas is configured to begin introducing the first gas into the interpane space within 2 seconds of the source of the second gas beginning to introduce the second gas into the enclosure.

In an embodiment, the source of the first gas is configured to introduce the first gas into the interpane space simultaneously with the source of the second gas introducing the second gas into the enclosure.

In an embodiment, the source of the first gas comprises a probe configured for insertion into the IGU passage.

In an embodiment, the probe comprises a low-friction coating or treatment.

In an embodiment, the IGU passage comprises an opening in the spacer frame configured to permit fluid communication with the interpane space.

In an embodiment, the IGU passage comprises an opening in the first or second sheet configured to permit fluid communication with the interpane space.

In an embodiment, the source of the first gas is configured to introduce the first gas into the interpane space at a first pressure and the source of the second gas is configured to introduce the second gas into the enclosure at a second pressure which is lower than the first pressure.

In an embodiment, the first gas is krypton.

In an embodiment, the second gas is argon.

In an embodiment, the second gas is air.

In an embodiment, the vacuum source is configured to reduce the absolute pressure of the existing gas in the enclosure about 0.1 pounds per square inch (psi).

In an embodiment, the source of the first gas is configured to introduce the first gas into the interpane space at an absolute pressure of about 14 psi.

In an embodiment, the sealing device comprises a press configured to press the second sheet on to the spacer structure.

A further system is described herein for replacing air with an interpane gas during manufacture of a sealed insulating glass unit (IGU). A sealed IGU comprises first and second sheets of glass material and a spacer structure formed into a spacer frame between the first and second sheets and sealed to the first and second sheets. The sealed IGU defines an interpane space filled with an interpane gas. The system comprises an enclosure means configured to enclose one or more unsealed IGUs; a vacuum source configured to evacuate an existing gas from the enclosure; a source of a first gas configured to introduce a first gas into the interpane space through an IGU passage for fluid communication; a source of a second gas configured to introduce a second gas into the enclosure; and a sealing means configured to seal the one or more unsealed IGUs, wherein sealing the one or more unsealed IGUs comprises closing the IGU passage.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE FIGURES

The technology may be more completely understood in connection with the following drawings, in which:

FIG. 1 is a perspective view of an insulating glass unit, according to an embodiment.

FIG. 2 is a front view of a first step of an example manufacturing process, where two unsealed insulating glass unit assemblies are positioned within an enclosure, according to an embodiment.

FIG. 3 is a front view of a further step of an example manufacturing process, where two unsealed insulating glass unit assemblies are positioned within an enclosure that has been evacuated of air, according to an embodiment.

FIG. 4 is a front view of a still further step of an example manufacturing process where two unsealed insulating glass unit assemblies are positioned within an enclosure, according to an embodiment.

FIG. 5 is a perspective view of a portion of an unsealed insulating glass unit assembly within an enclosure, according to an embodiment.

FIG. 6 is a side view of an unsealed insulating glass unit assembly within an enclosure, according to an embodiment.

FIG. 7 is a perspective view of a portion of an unsealed insulating glass unit assembly within an enclosure, according to an embodiment.

FIG. 8 is a side view of an unsealed insulating glass unit assembly within an enclosure, according to an embodiment.

FIG. 9 is a cross-sectional side view of an unsealed insulating glass unit assembly within an enclosure, according to an embodiment.

FIG. 10 is a side view of an unsealed insulating glass unit assembly within an enclosure, according to an embodiment.

FIG. 11 is a front, cutaway view of a portion of an unsealed insulating glass unit assembly within an enclosure, according to an embodiment, with view taken through a cross-section of a filling probe.

FIG. 12 is a cross-sectional view of a filling probe, according to an embodiment.

FIG. 13 is a flow chart depicting a method of filling an insulating glass unit with a gas, according to an embodiment.

FIG. 14 is a front view of a step of an example manufacturing process, where two partially assembled IGUs are positioned within an enclosure and filling blocks are positioned near the unsealed IGUs.

FIG. 15 is perspective view of one of the filling blocks of FIG. 14.

FIGS. 16, 17 and 18 are views of an inlet side, curved side and front, planar outlet side of the filling block of FIG. 14, respectively.

FIG. 19 is a cross-sectional view of the filling block of FIG. 14, taken through line A-A of FIG. 18.

FIG. 20 is a side view of the enclosure of FIG. 14, now including a press plate, with the filling block positioned between sheets of a wedge-sealed IGU.

FIG. 21 is an enlarged view of Detail A of FIG. 20.

FIG. 22 is a cross-sectional view of a portion of the wedge-sealed IGU of FIG. 20, taken through an inlet of the filling block.

FIG. 23 is an enlarged view of Detail B of FIG. 22.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Windows that are installed in buildings and other structures frequently include an insulating glass unit surrounded by a frame. The insulating glass unit can include a first sheet of glass material and a second sheet of glass material. Some insulating glass units can further include a third sheet of glass material. A spacer can separate the first sheet from the second sheet. The spacer can extend around the insulating glass unit near the perimeter of the insulating glass unit. The first sheet, second sheet, and spacer define an interpane space or volume that can be initially filled with air, such as air from the ambient environment of the manufacturing facility. In various embodiments, the air can be replaced with a different gas, such as to increase or affect the insulating properties of the window. Various different gases have different insulating properties.

In some examples, the gas used to fill the interpane space can be relatively expensive. As such, it can be desired to have a more efficient system and method for filling the interpane space with an insulating gas that minimizes waste of the insulating gas during the manufacturing process. In some examples, it can be desired to have a system and method for filling the interpane space with an insulating gas that minimizes the waste of a first gas. For example, a second gas can be used to surround the environment for filling with a first gas. In an example, a second gas can be used so that it is more likely that a second gas is wasted if waste occurs.

In an embodiment, an unsealed glass unit is positioned within an enclosure. The air within the enclosure and within the unsealed glass unit is evacuated to create a low pressure system or vacuum within the glass unit and enclosure. A first gas is introduced into the interpane space and a second gas is introduced into the enclosure. The first gas can be introduced simultaneously as the second gas, or one of the gases can be introduced shortly after the other gas, such as within 1 or 2 seconds.

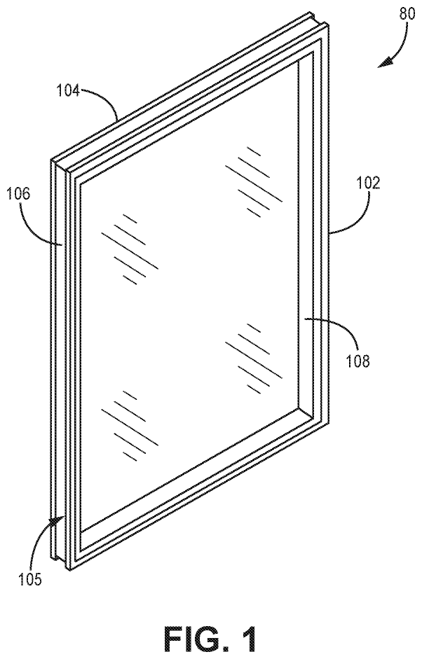

FIG. 1 is a perspective view of a completed, sealed insulating glass unit, according to an embodiment. The insulating glass unit (“IGU”) 80 can include a first sheet 102 and a second sheet 104. The IGU 80 can include a spacer 106 disposed between the first sheet 102 and the second sheet 104. In an embodiment, the spacer 106 is slightly inset from the perimeter of the first sheet 102 and the second sheet 104. FIG. 1 shows an example of the spacer 106 being inset from the perimeter of the first sheet 102 and the perimeter of the second sheet 104. In various examples, a frame will be added around the perimeter of the IGU 80 prior to the IGU 80 being installed in a building or home.

The first sheet 102 and the second sheet 104 can include a translucent, transparent, or semi-transparent material, such as to allow light to pass through the two sheets 102, 104 or to allow a person to see through the two sheets 102, 104. In various embodiments, the first sheet 102 and the second sheet 104 include a glass material or glass or plastic, such as a clear or translucent glass or plastic. In various embodiments, the first sheet 102 and the second sheet 104 can be similar, such that the two sheets 102, 104 have a substantially similar shape and/or size.

The spacer 106 can be coupled to the first sheet 102 and the second sheet 104. The spacer 106 can extend from the first sheet 102 to the second sheet 104, such as to define a volume or an interpane space 108. The interpane space 108 is defined between the first sheet 102 and the second sheet 104. The spacer 106 also forms a boundary of the interpane space 108.

The spacer 106 is formed into a spacer frame 105 that surrounds the interpane space 108. The spacer frame 105 has a shape that matches the outer perimeter shape of the IGU 80. For example, where the IGU 80 is rectangular as in FIG. 1, the spacer frame 105 is a rectangle. In some embodiments, the spacer frame 105 can be generally rectangular, such as a rectangular shape with rounded corners. In various embodiments, the spacer frame 105 can have rounded corners and the outer perimeter of the IGU can be rectangular with square corners.

In various embodiments, a completed IGU 80 can be sealed, such as to trap an interpane gas within the interpane space 108. The sealed IGU 80 can retain the interpane gas within the interpane space 108 and prevent external gasses from entering the interpane space 108.

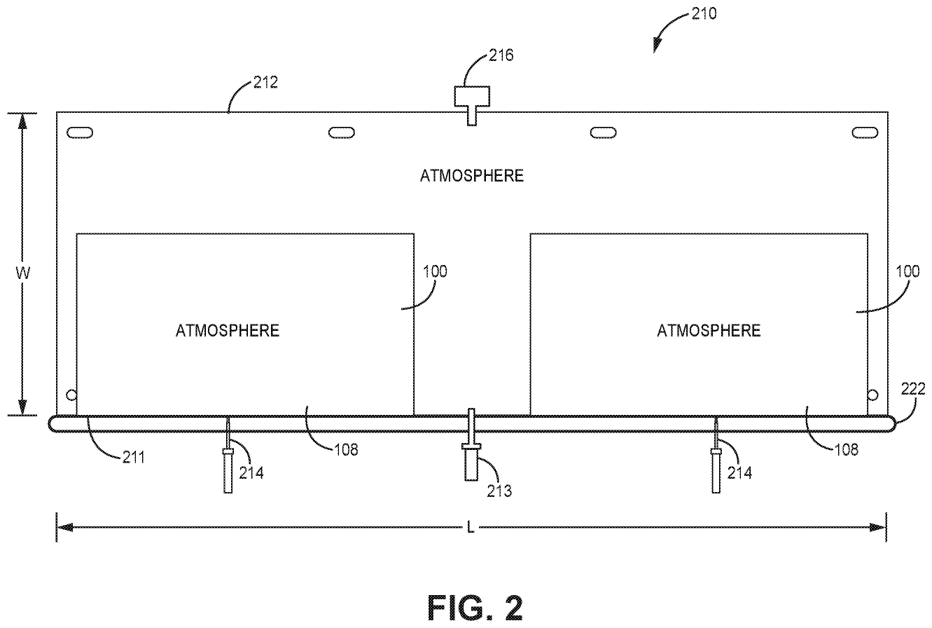

FIGS. 2-4 generally show various stages of a system 210 for replacing air with an interpane gas during the manufacturing of a sealed IGU. The system 210 can include an enclosure 212. In an embodiment, the enclosure 212 can have a depth of about 2 inches. In an embodiment, the enclosure 212 can have a depth that is about twice the depth of an IGU. In an embodiment, the enclosure 212 can have a width W of about 60 inches and a length L of about 170 inches.

The enclosure 212 can be configured to enclose one or more IGUs 100. In an embodiment, the enclosure 212 can enclose a single IGU, two or more IGUs, three or more IGUs, four or more IGUs, five or more IGUs, or six or more IGUs. FIGS. 2-4 show an enclosure with two IGUs 100. In an embodiment, the system 210 can include a support structure 222 to support the one or more IGUs 100 within the enclosure 212. In an embodiment, the support structure 222 can include a conveyor belt 211.

FIG. 2 shows an initial stage of the manufacturing process where unsealed IGU assemblies 100 within the enclosure. The IGUs can be unsealed when they enter the enclosure 212. An unsealed IGU assembly (also referred to as unsealed IGU) can have one or more fluid communication passages between the interpane space 108 and a surrounding environment external to the IGU.

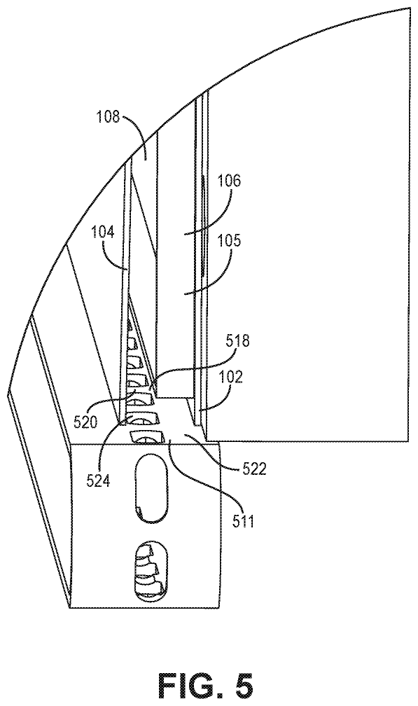

There are several options for defining the one or more fluid communication passages to the interpane space 108 in an unsealed IGU assembly. For example, the unsealed IGU assembly can be a partially assembled IGU that is unsealed along at least a portion of the spacer frame and at least one of the sheets, but sealed along the remaining portion of the spacer frame. For example, the partially assembled IGU can be unsealed along at least one side of a spacer frame and sealed along at least one other side of the spacer frame. An IGU passage to the interpane space of the partially assembled IGU is defined at the unsealed edge portion in these examples. One example of such a partially assembled IGU is a tented IGU shown in FIG. 5 and described with respect to FIG. 5.

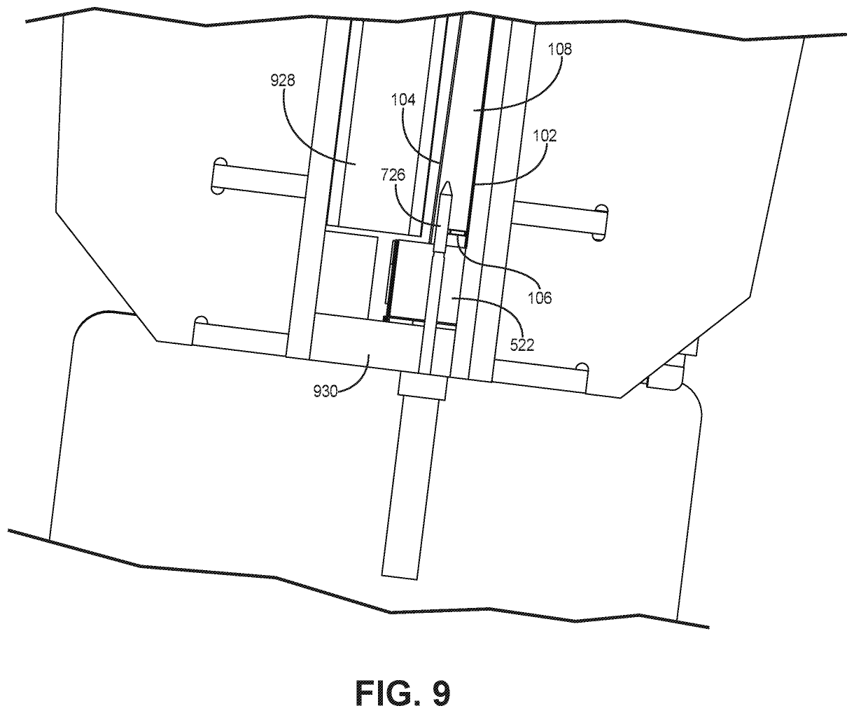

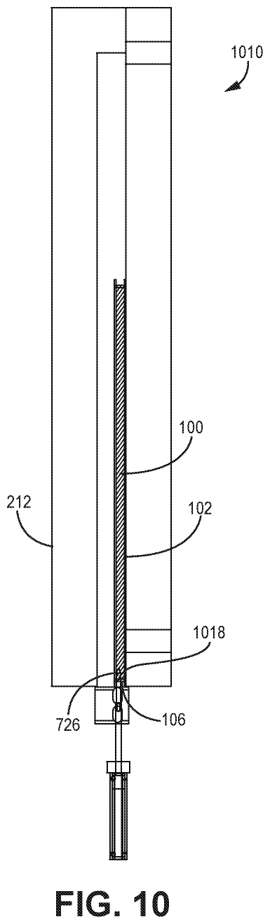

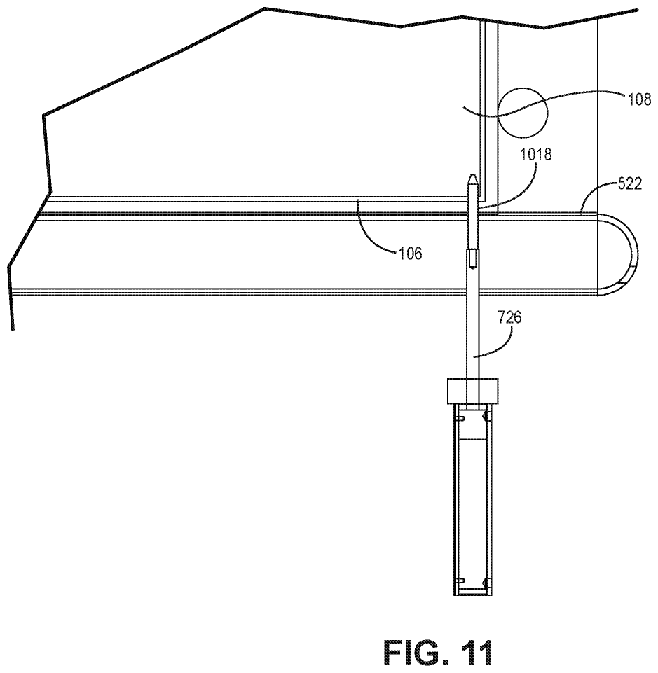

In another example of an unsealed IGU assembly, an IGU passage to the interpane space is defined through an opening in the spacer frame, where the sheets are both sealed to the spacer frame along a perimeter of the spacer frame. An example of such an IGU assembly is shown in FIGS. 10-11 and described with respect to FIGS. 10-11.

In yet another example of an unsealed IGU assembly, an IGU passage is defined through an opening in the first or second sheet.

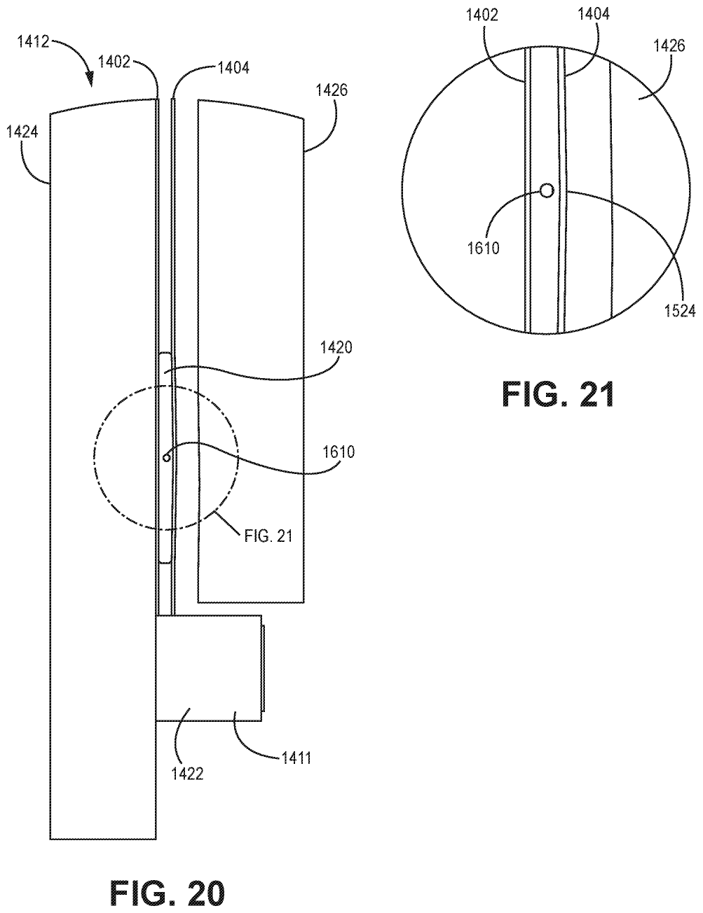

In yet another example, the unsealed IGU assembly is a wedge-sealed IGU where a filling block is positioned between the glass sheets outside of a perimeter of the spacer frame. The filling block causes a wedge-passage to be defined between the spacer and one of the sheets. The filling block defines a filling block passage that is in fluid communication with the wedge-passage. One example of such an embodiment is shown in FIGS. 20-23 and described with respect to FIGS. 20-23. In various embodiments, including the embodiment of FIGS. 20-23, the filling block is pressed against the spacer during the manufacturing process. The face of the filling block that contacts the spacer includes a foam layer or other compressible material, in one embodiment, to improve the seal formed between the filling block and the spacer.

In still another embodiment, the unsealed IGU assembly includes a filling block positioned between a glass sheet and the spacer, causing a passage to be defined between the spacer and the glass sheet.

As shown in FIG. 2, when the unsealed IGUs first enter the enclosure 212, both the enclosure 212 and the unsealed IGUs 100 can be filled with ambient air from the atmosphere in which the system 210 is located, such as a manufacturing facility. The enclosure 212 can then be sealed, such as to prevent the unintended flow of gases from outside the enclosure 212 to the inside, or from inside the enclosure 212 to outside.

The system 210 can further include a vacuum source 213 configured to evacuate the existing gas or air from the interior of the enclosure 212. The vacuum source 213 can further evacuate the existing gas from the interpane space 108 of the unsealed IGU 100, because the unsealed IGUs are within the enclosure. If an IGU assembly within the enclosure is unintentionally sealed rather than unsealed, the process of evacuating the chamber will cause such a sealed IGU to break its seal, such as by the glass sheets shattering, to equalize pressure between the interpane space and the enclosure.

The vacuum source 213 can be configured to reduce the absolute pressure of the existing gas in the enclosure 212 to about 0.1 pounds per square inch (psi). In various embodiments, the vacuum source 213 can be configured to reduce the absolute pressure in the enclosure 212 to less than 0.1 psi, less than 0.2 psi, or less than 0.5 psi. The system 210 can include a source 214 of a first gas. In an embodiment, the source 214 can be a portion of a conveyor belt or other support structure which the unsealed IGU rests upon, such as through holes in a conveyor belt shown in FIG. 5 positioned below a bottom gap formed by an unsealed IGU assembly. In an embodiment, the source 214 can be in the form of a probe, such as shown in FIGS. 2-4 and 7-11. In an embodiment, the source 214 of the first gas is configured to introduce the first gas into the interpane space 108 at an absolute pressure of about 28 psi. In an embodiment, the source 214 of the first gas is configured to introduce the first gas into the interpane space 108 at an absolute pressure of about 14 psi. In an embodiment, the source 214 of the first gas is configured to introduce the first gas into the interpane space 108 at an absolute pressure of at least 10 psi.

The source 214 of first gas can be configured to introduce the first gas into the interpane space through an IGU passage for fluid communication (shown in FIG. 5). In various embodiments, the source 214 is configured to be positioned below the IGU passage, such that as gas is released from the source 214, the gas travels through the IGU passage and into the interpane space 108. In an embodiment, the first gas can include a noble gas. In an embodiment, the first gas can include krypton or xenon. In various embodiments, the first gas is a blend of krypton and argon, a blend of krypton and air, a blend of xenon and argon, a blend of krypton and xenon, a blend of xenon and air, or other gas blends.

The system 210 can include a source 216 of a second gas. The source 216 of a second gas can be configured to introduce the second gas into the enclosure 212. In various embodiments, the second gas is introduced to the volume within the enclosure 212 at a location that is external to the interpane space 108 and is not adjacent to the IGU passage. In an embodiment, the second gas can include a noble gas. In an embodiment, the second gas can include argon or ambient air. In various embodiments, the second gas is argon, an argon blend with other gasses, or an argon-air blend.

In various embodiments of the system 210, the source 214 can be configured to introduce the first gas into the interpane space 108 at a time overlapping in time with the source 216 introducing the second gas into the enclosure 212. In such an embodiment, the source 214 will be introducing the first gas into the interpane space 108 at the same time the source 216 is introducing the second gas into the enclosure 212. In an embodiment, the source 214 of the first gas is configured to begin introducing the first gas into the interpane space 108 within 2 seconds of the source 216 of the second gas beginning to introduce the second gas into the enclosure 212. In an embodiment, the source 216 begins introducing the second gas into the enclosure prior to the source 214 introducing the first gas into the interpane space 108. In an embodiment, the source 214 begins introducing the first gas into the interpane space 108 prior to the source 216 introducing the second gas into the enclosure 212. In an embodiment, the source 214 of the first gas is configured to introduce the first gas into the interpane space 108 simultaneously with the source 216 of the second gas introducing the second gas into the enclosure 212. In an embodiment, the source 214 of the first gas is configured to begin introducing the first gas into the interpane space 108 simultaneously with the source 216 of the second gas beginning to introduce the second gas into the enclosure 212. In various embodiments of the system 210, the source 214 and source 216 can introduce the desired about of gases into the enclosure 212 and the interpane space 108 in 30 seconds or less, 15 seconds or less, or 10 seconds or less.

In an embodiment, the source 214 of the first gas is configured to introduce the first gas into the interpane space 108 at a first pressure and the source 216 of the second gas is configured to introduce the second gas into the enclosure 212 at a second pressure which is lower than the first pressure. In an embodiment, the second pressure can be about 14 psi and the first pressure can be 14 psi or slightly greater, such as 15 psi.

The system 210 can further include a sealing device configured to seal the one or more unsealed IGUs after the first gas has been introduced into the interpane space 108. The sealing device can seal the one or more unsealed IGUs by closing or sealing the one or more IGU passages.

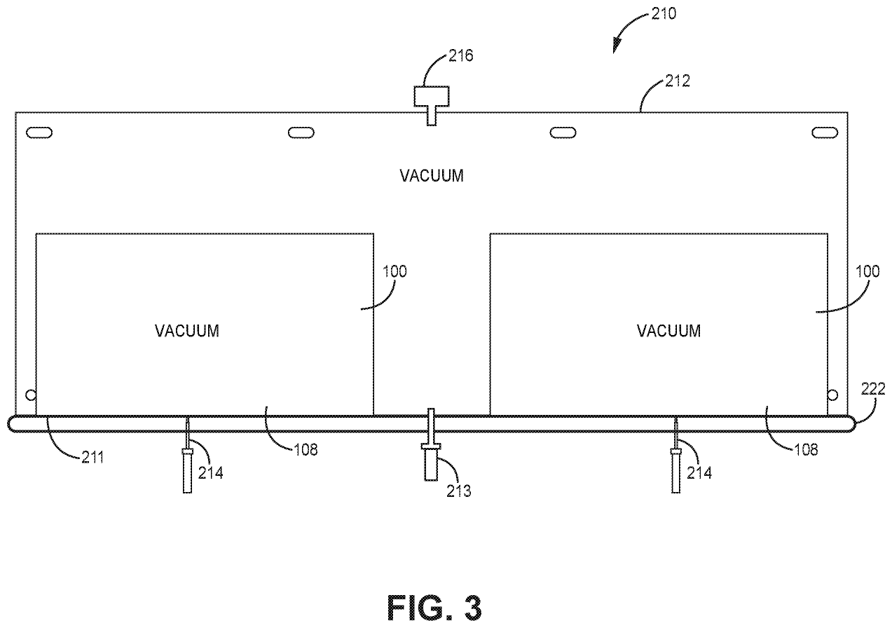

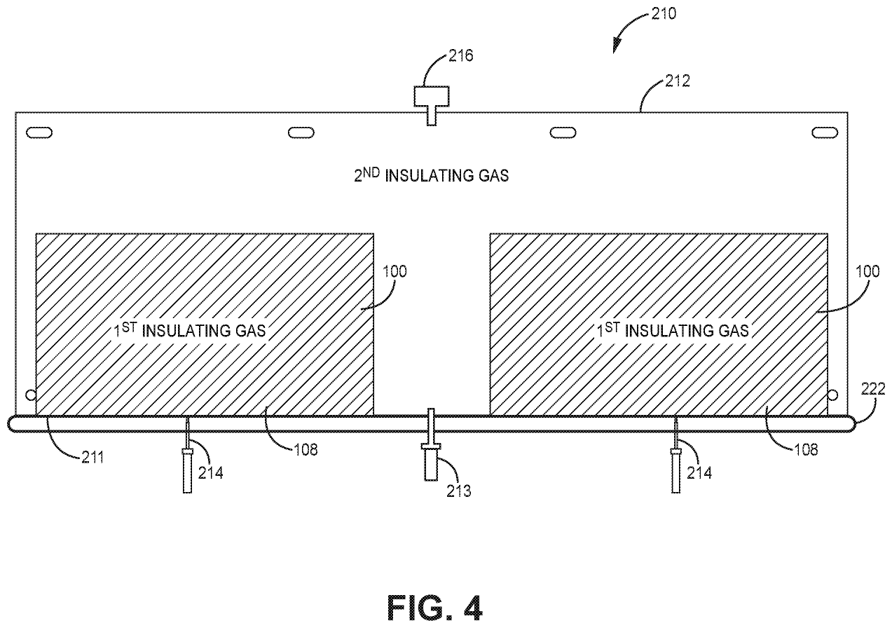

Some general steps and aspect of a system of various examples will now be described with reference to FIGS. 2-4. FIG. 2 shows a representation of two unsealed IGUs 100 within the enclosure 212. Initially, the enclosure 212 and the interpane space 108 can be occupied by ambient air, as noted in FIG. 2. The enclosure 212 is then sealed off from the ambient environment. The vacuum source 213 can be configured to remove the ambient air from the enclosure 212 and the interpane space 108, so that both the enclosure 212 interior and the interpane spaces 108 are at a vacuum, as noted in FIG. 3. Once the ambient air is removed from the enclosure 212 and the interpane space 108, the first gas can be introduced into the interpane space 108 and the second gas can be introduced into the enclosure 212, as shown in FIG. 4. In some embodiments, some of the second gas can travel into the interpane space 108. As a result, in some embodiments, the interpane space will be occupied by the first gas and a portion of the second gas.

After the interpane space 108 has been filled to the desired amount of gas, the IGU can be sealed, such as by sealing the IGU passage to stop to flow of gases into or out of the interpane space 108. In some embodiments, the interpane space 108 can be filled with 100% of the first gas after the IGU passage is sealed. In some embodiments, the interpane space 108 can be filled with 95% first gas and 5% second gas after the IGU passage is sealed. In some embodiments, the interpane space 108 can be filled with 90% first gas and 10% second gas after the IGU passage is sealed. In some embodiments, the interpane space 108 can be filled with 85% first gas and 15% second gas after the IGU passage is sealed. In some embodiments, the interpane space 108 can be filled with 80% first gas and 20% second gas after the IGU passage is sealed. In some embodiments, the interpane space 108 can be filled with 75% first gas and 25% second gas after the IGU passage is sealed. In some embodiments, the interpane space 108 can be filled with 70% first gas and 30% second gas after the IGU passage is sealed. In some embodiments, the interpane space 108 can be filled with 60% first gas and 40% second gas after the IGU passage is sealed. In some embodiments, the interpane space 108 can be filled with 50% first gas and 50% second gas after the IGU passage is sealed.

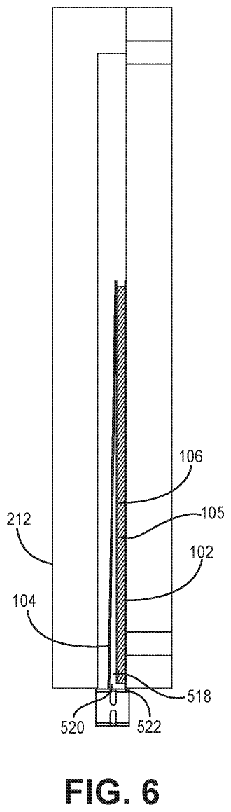

FIG. 5 shows a perspective cut-away view of a portion of an unsealed IGU assembly 100 within an enclosure 212, according to an embodiment. FIG. 6 shows an end view of the IGU 100 within the enclosure 212. FIGS. 5 and 6 both show a bottom portion of the second sheet 104 positioned away from the spacer 106 to define an IGU passage 518.

In an embodiment, the unsealed IGU assembly includes the spacer frame 105 sealed to the first sheet 102. The IGU passage 518 can include a bottom gap 520 between the spacer 106 and the lower edge of the second sheet 104. The lower edge of the second sheet 104 can be spaced or located a distance away from the spacer 106 to define the bottom gap 520. In an embodiment, the bottom gap 520 extends along the entire length of the IGU 100. In an embodiment, the bottom gap 520 has a width from the edge of the spacer frame 105 to the second sheet 104 of at least 0.05 inches and not more than 1 inch. The IGU passage 518 can be configured to allow the first gas to be introduced into the interpane space 108. The system 210 can further include a support structure 522 that can be configured to support, hold or otherwise secure the unsealed IGU in the enclosure 212, such as while the gases are introduced. In an embodiment, the support structure 522 can include a conveyor belt 511, shown in FIG. 5. The support structure 522 can also be configured to transport the one or more IGUs within the enclosure 212 and/or into or out of the enclosure 212. The support structure 522 is positioned entirely within the enclosure 212 in one embodiment.

In an embodiment, the support structure 522 can define a support passage 524 for fluid communication between the source 214 of the first gas and the IGU passage 518. In an embodiment, the support passage 524 can be in the form of one or more apertures or holes, such as shown in FIG. 5. The source 214 of the first gas can be located below or on the opposite side of the apertures from the IGU passage 518, such that the first gas travels from the source 214, through the support structure 522 via the support passage 524 and into the interpane space 108 via the IGU passage 518.

In various examples, the support structure 522 defines multiple support passages 524. In various examples, the passages 524 are defined at regular intervals along the length of the support structure 522. In one example, the support passages 524 in the support structure can be selectively opened or closed depending on the placement of the unsealed IGU assemblies along the support structure during a manufacturing cycle. The support passages 524 that are directly beneath an unsealed IGU assembly can be open while the remainder of the passages 524 can be closed, in one example.

The system 210 can further include a sealing device within the enclosure 212. The sealing device can be configured to seal or close the IGU passage after the interpane space 108 has been filled with the gas, such as to trap the gas within the interpane space 108. In an embodiment, the sealing device comprises a press. The press can be configured to press the second sheet on to the spacer 106, such as to close or seal the IGU passage 518.

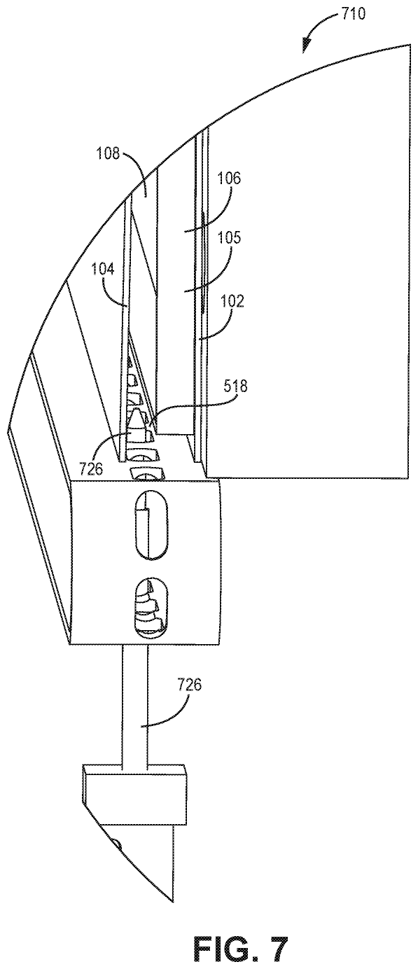

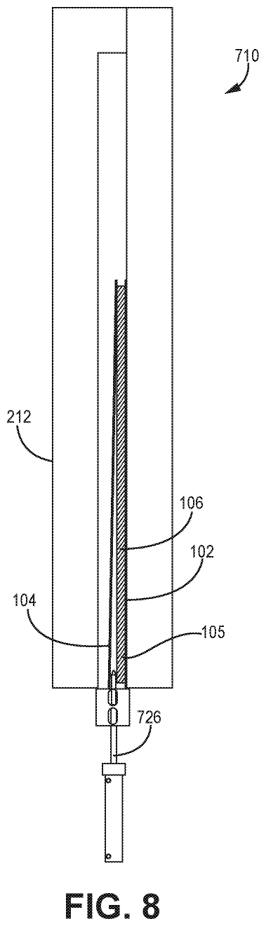

FIG. 7 shows a perspective cut-away view of a portion of an alternate system 710 and FIG. 8 shows an end view of the alternate system 710, which includes an unsealed IGU assembly 100 within an enclosure 212, according to an embodiment. FIGS. 7 and 8, similar to FIGS. 5 and 6, show the bottom portion of the second sheet 104 away from the spacer 106 to define the IGU passage 518.

In system 710, the source 214 for the first gas can include a probe 726. The probe 726 can be configured to be inserted into the IGU passage 518. In various embodiments, the probe 726 can partially extend into the interpane space 108.

In various embodiments, the spacer 106 includes adhesive or sealant (not shown) positioned on its side for securing and sealing the second sheet 104 to the spacer 106. The probe 726 can include a low-friction coating, such as to avoid or reduce the chance of removing adhesive that is positioned on the spacer 106 when the probe 726 is inserted or removed from the IGU passage. A low-friction coating on the probe 726 can also reduce the likelihood of damage to the second sheet 104 and the spacer 106 when the probe 726 is inserted or removed from the IGU passage. In various embodiments, the low friction coating can include a coating that provides high surface energy or high contact angle such as titanium nitride, titanium carbide, carbon, polytetrafluoroethylene (PTFE), TEFLON™ coating of PTFE available from DuPont Co., and crystalline polymers. In various embodiments, the probe 726 includes a low-friction treatment. In various embodiment, the low friction coating includes a residue or partial coating from a treatment of plasma, gas, or liquid exposure.

FIG. 9 shows a cross-sectional side view of an unsealed IGU assembly 100 within an enclosure 212, according to an embodiment. FIG. 9 shows the probe 726 extending through the IGU passage 518 defined by the bottom portion of the second sheet 104 and the spacer 106. FIG. 9 further shows the probe 726 extending into the interpane space 108. FIG. 9 further illustrates one example of a press plate 928 for pressing against the second sheet 104 to seal the second sheet 104 to the spacer 106, after the probe 726 has been withdrawn. FIG. 9 also shows a bottom portion 930 of the enclosure surrounding the support structure 522.

FIG. 10 shows a side view and FIG. 11 shows a close-up front view of one portion of an alternate system 1010 for filling an unsealed IGU assembly 100 with gas within an enclosure 212, according to an embodiment. In an embodiment, an IGU passage 1018 is defined by an opening in the spacer frame 105. The IGU passage 1018 can be configured to permit fluid communication with the interpane space. In various embodiments, the IGU passage 1018 can be configured so that the probe 726 can at least partially extending through it, such as shown in the FIGS. 10-11.

In some embodiments, the IGU passage 1018 can be located near a corner of the IGU 100. In an embodiment, the IGU passage 1018 can be located in the middle of one of the sides of the IGU, such as shown in FIGS. 2-4. In an embodiment, the IGU passage can be located on a bottom side of the IGU, such as shown in FIGS. 2-4. In an embodiment, the IGU passage 1018 can be located in the spacer frame 106 on the top side of the IGU.

In an alternative embodiment, the IGU passage is defined by an opening in the first or second sheet 102, 104, such that the probe 758 can at least partially extend through the first sheet 102 or the second sheet 104 and into the interpane space 108. The IGU passage in the spacer frame or a sheet can be sized to allow escape of the ambient air around an outer diameter of the probe 726.

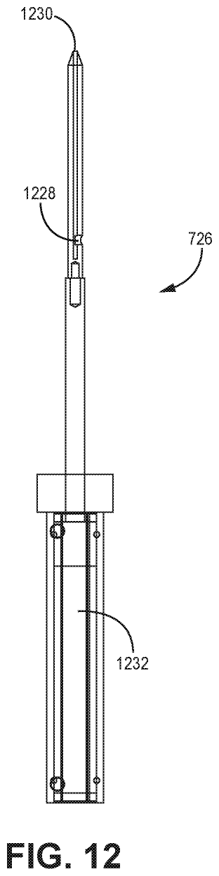

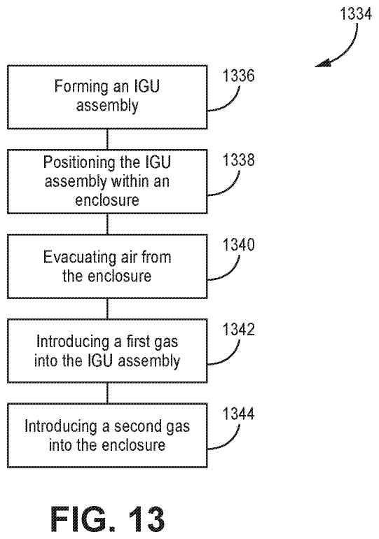

FIG. 12 is a front view of a filling probe 726, according to an embodiment. The filling probe 726 is positioned behind the second sheet of glass material. The filling probe 726 can introduce the first gas into the interpane space. In an embodiment, the filling probe 726 can include a cylindrical shaft with an input port 1228 and an output port 1230. The input port 1228 can be configured to receive the first gas from an exterior source, such as a compressor or a tank of compressed gas. The output port 1230 can be configured to discharge the first gas from the probe 726, such as to fill the interpane space. The filling probe 726 can include an actuator 1232, such as to extend or retract the filling probe. Initially, the filling probe 726 can be located external to the interpane space, external to the enclosure, or external to both the enclosure and the interpane space. Once the unsealed IGU assembly is in place within the enclosure, the actuator 1232 can extend the filling probe 726 into the desired location, such as the IGU passage, to introduce the first gas into the interpane space. Once the IGU has been filled with the desired amount of gas, the filling probe can be retracted or removed from the filling location, such that the IGU can be sealed and removed from the enclosure. In an embodiment, the actuator 1232 is a pneumatic actuator. In an embodiment, the actuator 1232 can be a compact air cylinder, such as the Square Pancake II Cylinder sold by Fabco-Air, Inc., Gainesville, Fla. FIG. 13 shows a flow chart depicting a method 1334 of replacing air with an interpane gas during the manufacture of a sealed IGU, according to an embodiment.

The method 1334 can include the step 1336 of forming an unsealed IGU assembly. Forming an unsealed IGU assembly can include securing or sealing a spacer frame to a first sheet of glass material. Forming the unsealed IGU assembly can further include partially securing the spacer frame to a second sheet of glass material. The unsealed IGU assembly can define an IGU passage between the interpane space and an ambient environment. In an embodiment, the IGU passage can be defined by positioning an edge of the second sheet a distance away from the spacer to provide a gap. In one embodiment, a lower edge of the second sheet is positioned a distance away from the spacer to provide a bottom gap. In another embodiment, an upper edge of the second sheet is positioned a distance away from the spacer to provide a top gap. In one embodiment, a side edge of the second sheet is positioned a distance away from the spacer to provide a side gap.

In an embodiment, forming an unsealed IGU assembly includes sealing the spacer frame to the first sheet and second sheet, and creating an opening in the spacer frame to permit fluid communication with the interpane space, such that the IGU passage is defined within the spacer frame. In an embodiment, forming an unsealed IGU assembly includes sealing the spacer frame to the first sheet and second sheet, and creating an opening in the first or second sheet to permit fluid communication with the interpane space, such that the IGU passage is defined by the first sheet or the second sheet.

The method 1334 can include the step 1338 of positioning the unsealed IGU assembly within an enclosure. This step can be accomplished by moving unsealed IGU assemblies into the open enclosure space using a conveyor belt or other manufacturing equipment. This step can be accomplished by forming the enclosure around the unsealed IGU assemblies. The enclosure can be sealed around the unsealed IGU assembly, such as to prevent air or other gasses from unintentionally entering or exiting the enclosure.

Once the unsealed IGU assembly is positioned within the enclosure, the method 1334 can include the step 1340 of evacuating the air from the enclosure. Evacuating the air from the enclosure can include removing the majority of the air from the enclosure, such that it can be replaced with a gas.

The method 1334 can further include the step 1342 of introducing a first gas into the interpane space through the IGU passage, and the step 1344 of introducing a second gas into the enclosure. The second gas can have a different composition than the first gas. In some embodiments, the second gas is less expensive to obtain than the first gas. In some embodiments, the first gas provides more insulation than the second gas. In some embodiments, the first gas provides a lower U-value to the finished IGU than the second gas, such that the first gas is better at reducing heat transfer than the second gas.

In some embodiments, introducing the first gas can include positioning the IGU passage over the source of the first gas. In an embodiment, a support structure can support the unsealed IGU assembly in the enclosure and the support structure can define a fluid communication passage between the source of the first gas and the IGU passage. In some embodiments, the step of introducing the first gas into the interpane space includes positioning a probe within the IGU passage and delivering the first interpane gas through the probe.

In some embodiments, beginning to introduce the first gas can occur simultaneously with beginning to introduce the second gas. In an embodiment, the step of introducing the first gas into the interpane space overlaps in time with the step of introducing a second gas into the enclosure. In an embodiment the beginning of the step of introducing the first gas into the interpane space occurs within 2 seconds of a beginning of the step of introducing a second gas into the enclosure. In an embodiment, the introduction of the first gas occurs at a first pressure and the introduction of the second gas occurs at a second pressure which is lower than the first pressure. In an embodiment, the second pressure can be about 14 psi and the first pressure can be 14 psi or slightly greater, such as 15 psi.

In some embodiments, the method 1334 can further include closing the IGU passage to seal the interpane space, such as to trap the gas within the interpane space. Where the IGU passage is a gap between the second sheet and the spacer, a press plate can push the second sheet against a sealant-laden side of the spacer to seal the interpane space in one embodiment. Where the IGU passage is an opening in the spacer frame or a sheet, a plug or other sealing material can be placed over or into the opening to seal the interpane space.

A further step is to open the enclosure in order to access the IGUs within the enclosure. The step of closing the IGU passage of the IGUs can take place before the enclosure is unsealed or opened to the environment, in various embodiments.

### Use of a Filling Block

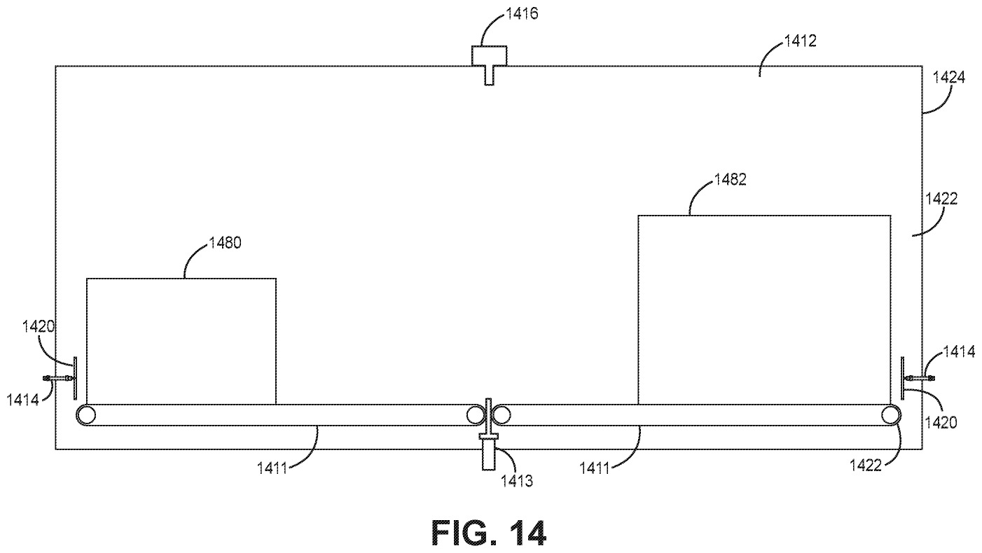

FIG. 14 shows a front view of a step of an example manufacturing process, where two partially assembled IGUs 1480, 1482 are positioned within an enclosure 1412 and filling blocks 1420 are positioned near the unsealed IGUs 1480, 1482.

In some embodiments, the manufacturing process or method can include loading one or more partially assembled IGUs 1480, 1482 into an open evacuating chamber 1412. In various embodiments, the loading of partially assembled IGUs can include loading multiple partially assembled IGUs into the chamber 1412. In some embodiments, the multiple IGUs can include IGUs of various size (as shown in FIG. 14). In some embodiments, the multiple IGUs can include IGUs of the same size. The loading of multiple partially assembled IGUs can include conveying the multiple partially assembled IGUs into the chamber 1412 in a linear manner. In an embodiment, the multiple partially assembled IGUs are conveyed into the chamber 1412 using a conveyor belt 1411. The partially assembled IGUs 1480, 1482 can include a first and second sheet of a glass material and a spacer structure formed into a frame between the first and second sheets.

In various embodiments, the chamber 1412 can include a support structure 1422. The support structure 1422 can support the IGUs 1480, 1482 while the IGUs 1480, 1482 are located within the chamber 1412, such as to support the IGUs 1480, 1482 in the desired position and/or configuration. In some embodiments, the support structure 1422 can include a conveyor belt 1411.

The partially assembled IGUs 1480, 1482 can define an open passage between a portion of the spacer frame and one of the sheets. The partially assembled IGUs 1480, 1482 can have a tent-like configuration, such that the sheet is angled away from or separated from the spacer along an edge, such as to provide a wider base that defines the open passage. FIG. 8 shows a tent-like configuration of an IGU with a probe 726 extending through the open passage between the second sheet 104 and the spacer 105.

The manufacturing process or method can include positioning the partially assembled IGU to a calculated position. The calculated position can ensure the open passage mates with a position of a filling device 1414. The filling device 1414 can be external, such that the filling device 1414 can be located at least partially outside of the chamber 1412. In some embodiments, the external filling device 1414 can be located within the chamber 1412 and be in fluid communication with a source external to the chamber 1412. The filling device 1414 can include a filling probe or a filling block. The filling device 1414 further includes a linear actuator to move the filing device into position, and to remove the filling block from between the glass sheets at the appropriate time.

The manufacturing process or method can include closing the chamber 1412 and evacuating the chamber to substantially remove all of the atmosphere from the chamber 1412 and the partially assembled IGU 1480, 1482. The chamber 1412 can be evacuated through a vacuum source 1413, such as discussed above.

The manufacturing process or method can include positioning a filling block 1420 in the open passage between the first sheet and the second sheet of the partially assembled IGU at a location outside of an external perimeter of the spacer frame.

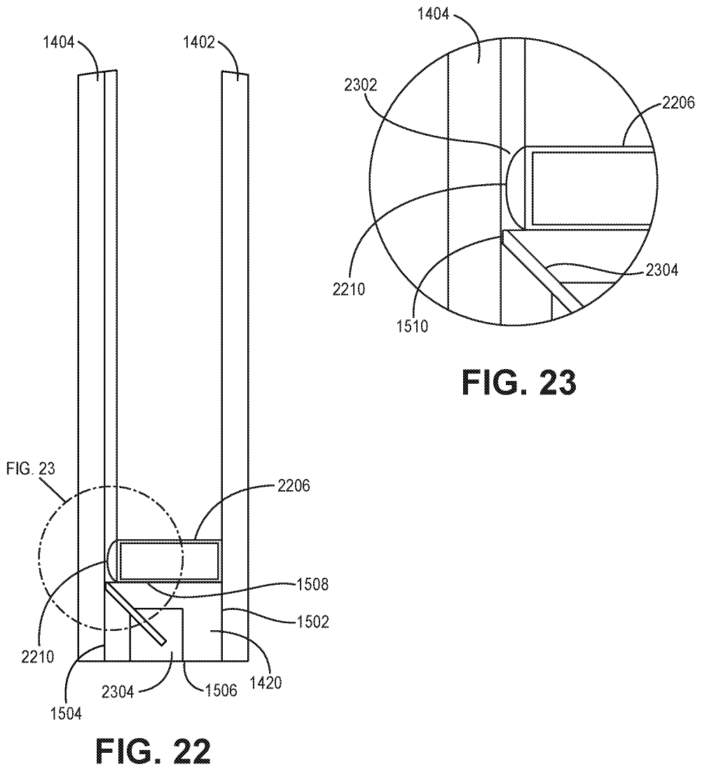

The manufacturing process or method can include closing the partially assembled IGU to close the open passage to create a wedge-sealed IGU with the filling block 1420 wedged between the first sheet and the second sheet. A wedge-sealed IGU can be a completely sealed IGU except with a wedge passage between one of the sheets and the spacer. The wedge passage can be a result of the filling block 1420 preventing sheet from being sealed to the spacer, such as shown in FIG. 22.

The filling block 1420 can define a filling block passage 2304. The filling block passage 2304 can allow the interior of the IGU to be in fluid communication with a filling device. The filling block passage can be aligned with the wedge passage to enable filling the wedge sealed IGU from the filling device, such as the filling probe.

The manufacturing process or method can include filling the wedge sealed IGU with a first gas from a source of first gas 1414 (as discussed above) while simultaneously filling the chamber 1412 with a second gas from a source for the second gas 1416 (as discussed above), such as air or argon to a near atmospheric pressure. The manufacturing process or method can further include retracting or removing the filling block 1420 from between the two sheets and then pressing the IGU, such as to create or form a hermetically sealed fully assembled IGU. The manufacturing process or method can finally include opening the chamber 1412 and unloading or removing the fully assembled IGU. In some embodiments that include multiple partially assembled IGUs within the chamber 1412, different first gases can be introduced to the interpane space of different IGUs 1480, 1482. The multiple different filling probes 1414 can each deliver a different first gas to a different IGUs 1480, 1482. For example, the first partially assembled IGU 1480 could be filled with Argon via a first filling probe 1414 and the second partially assembled IGU 1482 could be filled with Krypton via a second filling probe 1414.

The method can include delivering a calculated amount of first gas to the interpane space of an IGU. In some embodiments, prior to introducing the first gas into the interpane space, the amount of gas that will be delivered can be calculated, such as to prevent overfilling or waste. In some embodiments, the amount of gas delivered to the interpane space is determined by the volume of the interpane space. In some embodiments, the amount of gas delivered is equivalent to the volume of the interpane space. In some embodiments, the amount of gas delivered is equivalent to the volume of the interpane space and an additional volume of gas as a safety factor to ensure complete filling of the interpane space. In various embodiments, only the calculated or predetermined amount of gas is discharged from the filling probe.

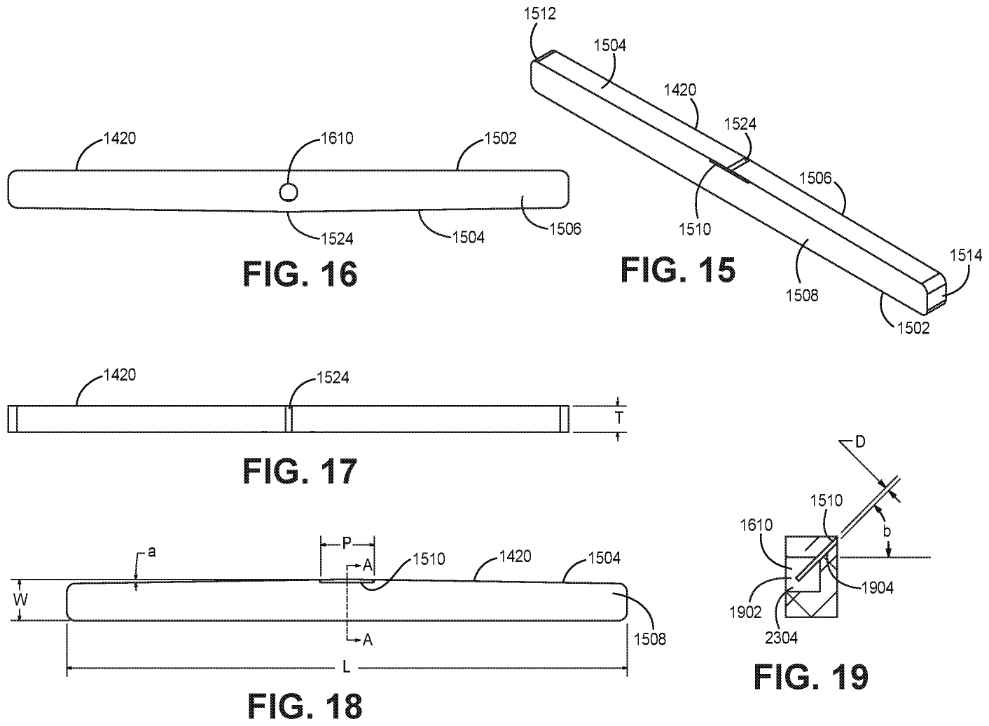

FIG. 15 shows a perspective view of one of the filling blocks 1420 of FIG. 14. The filling block 1420 can include a first end 1512 and a second end 1514. The filling block 1420 can include a planar side 1502, a curved non-planar side 1504, an inlet side 1506, and an outlet side 1508. In some embodiments, the outlet side 1508 can define an outlet 1510 of the filling block passage (as shown in FIGS. 15 and 18). In some embodiments, the curved non-planar side 1504 can define the outlet 1510 (as shown in FIGS. 22 and 23). In some embodiments, the curved non-planar side 1504 and the outlet side 1508 can both define the outlet 1510.

In an embodiment, the curved non-planar side 1504 can result in a portion of the filling block 1420 having a greater width than the remainder of the filling block 1420, such as a middle portion 1524. In an alternative embodiment, the filling block does not include a curved side and has a uniform width sufficient to define the wedge-passage.

In various embodiments, the filling block 1420 can be a generally rectangular prism, such as having four planar sides and non-planar ends 1512, 1514. In other embodiments, the filling block 1420 can be rectangular prism, such as having six planar sides.

FIGS. 16, 17 and 18 are views of an inlet side 1506, curved side 1504 and front, planar outlet side 1508 of the filling block of FIG. 14, respectively. The filling block 1420 can be wider in the middle than at the ends, such as shown in FIG. 18.

FIG. 19 is a cross-sectional view of the filling block 1420 of FIG. 14, taken through line A-A of FIG. 18. In various embodiments, the filling block passage includes an inlet 1610 defined by a first side (inlet side 1506) of the filling block 1420 and an outlet 1510 defined by the filling block 1420 at an edge of a second side (outlet side 1508) of the filling block 1420. In some embodiments, the outlet is positioned at the widest middle part of the filling block. In some embodiments, the first side can be opposite from the second side of the filling block 1420. In other embodiments, the first side (inlet side 1506) can define an inlet 1610 and the second side (curved non-planar side 1504) can define the outlet 1510. In some embodiments, the first side and second side can be adjacent and/or perpendicular.

In an embodiment of a method of automatically filling an IGU of the flowchart of FIG. 13, the partially assembled IGUs have a closed top portion and an open bottom portion. First, at least one partially assembled IGU with a closed top portion and open bottom portion is loaded into an opened air/gas evacuating chamber. Then the loaded partially assembled IGU is moved to a predetermined position or calculated position which aligns or mates with filling nozzles positioned within a conveyor system or lower part of chamber. Next, the chamber is closed. Next, the chamber is evacuated to substantially remove all atmosphere from the chamber and partially assembled IGUs. A first gas is introduced into the partially assembled IGUs through the partially opened bottoms. A second gas is introduced to fill the chamber. These two filling steps happen simultaneously in one embodiment. In one embodiment these two filling steps start at the same time. Then the partially assembled IGUs are closed to create a fully sealed IGU within the chamber. Next the chamber is opened. Next the fully assembled and sealed IGUs are unloaded. This process can be repeated by moving a next group of partially assembled IGUs into the chamber.

These steps can also be performed on multiple IGUs at one time, by loading multiple IGUs into the chamber. The multiple IGUs can be of the same size or various sizes. In one embodiment, the multiple IGUs are loaded into the chamber in a linear manner, one after another, through a side of the open evacuation chamber. One way of doing this is using a conveyor belt to move the IGUs into the chamber.

### Dimensions of Filling Block

Now referring to FIGS. 15-19, in one embodiment, the filling block 1420 has a length L of about 8 inches. In various embodiment, the length L is at least 7 inches and at most 9 inches. In various embodiment, the length L is at least 6 inches and at most 10 inches. In various embodiment, the length L is at least 4 inches and at most 12 inches. In various embodiments, the length L is at least 3 inches, at least 4 inches, at least 5 inches, at least 6 inches, at least 7 inches, at least 8 inches and at least 9 inches. In various embodiment, the length L is at most 12 inches, at most 11 inches, at most 10 inches, at most 9 inches, at most 8 inches, at most 7 inches and at most 6 inches.

The width W of the filling block is selected so that it will create a wedge-passage for passage of filling glass between a sheet and a sealant-laden spacer in a wedge-sealed IGU. In one embodiment, the width W is at least 1% larger than a width of the spacer. In various embodiments, the width W is at least 2%, 3%, 3%, 5%, 6% and 7% larger than a width of the spacer. In various embodiments, the width W is at most 10% and at most 15% larger than a width of the spacer.

In one embodiment, the filling block has a width W at the widest middle portion 1524 of about 0.6 inches or 0.587 inches. The filling block is narrower at its ends. The slope a of the surface from middle portion 1524 to each end is 0.86 to 1 degree from a line tangent to the surface at the middle portion 1524. The thickness T of the filling block is 0.375 inches. The length P of the outlet 1510 of the filling block passage is about 0.8 inch or about 0.765 inch.

The width D of the outlet 1510 of the filling block passage 2304, shown in FIG. 19, is about 0.030 inch. The filling block passage 2304 includes an inlet cavity 1902 adjacent to the inlet 1610, shown in the cross-section of FIG. 19. A diagonal passage 1904 leads from an inlet cavity 1902 to the outlet 1510 which is shown in the cross-section of FIG. 19. The angle b of the diagonal passage 1904 compared to a line parallel to side 1502 is about 45 degrees.

### Filling Block Materials

In various embodiments, the filling block 1420 can include a polymer, such as polyethylene terephthalate, polystyrene, polyvinyl chloride, polytetrafluoroethylene, nylon, or polyoxymethylene. In other embodiments, the filling block 1420 can include a core and a covering. The core can include a metal, such as aluminum. The covering can include a polymer, such as those listed above. In additional embodiments, the filling block 1420 can include one or more surfaces that include a protective layer, such as a foam layer, to protect the first or second sheet from damage as the filling block 1420 is inserted or removed from between the sheets.

### Filling Block Embodiment in Evacuation Chamber—FIGS. 20-23

FIG. 20 is a side view of the enclosure 1412 of FIG. 14, now including a press plate 1426, with the filling block 1420 positioned between sheets 1402, 1404 of a wedge-sealed IGU. FIG. 21 is an enlarged view of Detail A of FIG. 20. FIG. 20 shows the IGU positioned between a wall 1424 of the enclosure, such as a portion of the support structure 1422, and a press plate 1426. The press plate 1426 can press the IGU against the support structure 1422 or wall 1424 to seal the first sheet 1402 with the second sheet 1404 and the spacer.

FIG. 22 shows a cross-sectional view of a portion of the wedge-sealed IGU of FIG. 20, taken through an inlet of the filling block 1420. FIG. 23 is an enlarged view of Detail B of FIG. 22. FIG. 22 shows a spacer 2206 disposed between a first sheet 1402 and a second sheet 1404. FIG. 22 further shows a sealant bead 2210. Another sealant bead (not shown) is disposed between the spacer 2206 and the first sheet 1402, such as to seal the spacer 2206 with the first sheet 1402. The second sealant bead 2208 is disposed between the spacer 2206 and the second sheet 1404, such as to seal the spacer 2206 with the second sheet 1404. In FIG. 22, the first sealant bead 2208 is sealing the spacer to the first sheet 1402. In contrast, the second sealant bead 2210 is not sealing the spacer 2208 to the second sheet 1404 in order to allow space for the wedge passage between the second sheet 1404 and the spacer 2206. The wedge passage 2302 (shown in FIG. 23) can allow fluid communication between the filling block passage 2304 and the interpane space, such as to allow the first gas to be introduced into the interpane space.

In some embodiments, the press plate 1426 defines a depression on an interior surface to accommodate the widest portion of the filling block 1420.

When the filling block 1420 is removed by the linear actuator 1414, the wedge-passage 2302 will close because of the tension caused by the flexibility of the glass sheet 1404. That tension will be sufficient to seal the spacer frame to the glass sheet 1404 in various embodiments. In another embodiment, the press plate 1426 can be activated to press down on the IGU to ensure the seal. If the press plate 1426 has a depression to accommodate a widest portion of the filling block, then the conveyor belt is activated to move the IGUs to a different position with respect to the depression before activating the press plate, so that the press plate will sufficiently seal the IGUs, in one embodiment.

When terms of orientation are used throughout the description, such as top and bottom, the drawings provide a reference for such understanding such terms. It should be understood that the concepts described herein can be practiced in alternative orientations to those described. For example, a gap in an unsealed IGU assembly is described as being a bottom gap in one example, but could be a side gap or top gap in alternative embodiments. The drawings illustrate support devices for the unsealed IGU assemblies including a conveyor belt and a nearly-vertical support surface adjacent to the conveyor belt, so that the unsealed IGU assemblies are held in a nearly vertical position. It is also possible to use different conveyor devices for the unsealed IGU assemblies that hold the assemblies at different orientations, such as horizontal or vertical.

Throughout the drawings and description, like reference numbers are used to refer to similar or identical parts.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

1-42. (canceled)

43. A method of filling with an interpane gas during manufacture of a sealed insulating glass unit (IGU), wherein a sealed IGU comprises first and second sheets of glass material and a spacer structure formed into a spacer frame between the first and second sheets and sealed to the first and second sheets wherein the sealed IGU defines an interpane space filled with an interpane gas, comprising the steps of:
forming an unsealed IGU assembly defining an IGU passage for fluid communication between an interpane space and an ambient environment;
positioning the unsealed IGU assembly within an enclosure and sealing the enclosure around the unsealed IGU assembly, wherein the unsealed IGU assembly is positioned using a support structure located underneath the IGU assembly;
evacuating air from the enclosure;
introducing a first gas into the interpane space through the IGU passage;
introducing a second gas into the enclosure, wherein the second gas has a different composition than the first gas; and
closing the IGU passage to seal the interpane space.

44. The method of claim 43, wherein the support structure comprises a conveyor belt.

45. The method of claim 43, wherein the step of forming an unsealed IGU assembly comprises:
sealing the spacer frame to the first sheet; and
positioning a lower edge of the second sheet a distance away from the spacer structure to provide a bottom gap, wherein the bottom gap is the IGU passage permitting fluid communication with the interpane space.

46. The method of claim 45, wherein the step of introducing a first gas into the interpane space comprises positioning the IGU passage over a source of the first gas and the support structure supports the unsealed IGU assembly and defines a support passage for fluid communication between the source of the first gas and the IGU passage.

47. The method of claim 43, wherein the step of introducing the first gas into the interpane space overlaps in time with the step of introducing a second gas into the enclosure.

48. The method of claim 47, wherein a beginning of the step of introducing the first gas into the interpane space occurs within 2 seconds of a beginning of the step of introducing a second gas into the enclosure.

49. The method of claim 43, wherein the step of introducing the first gas into the interpane space occurs at a first pressure and the step of introducing the second gas into the enclosure occurs at a second pressure which is lower than the first pressure.

50. The method of claim 43, wherein the first gas is krypton.

51. The method of claim 50, wherein the second gas comprises one of a group of argon and air.

52. The method of claim 43, wherein the step of evacuating air from the enclosure comprises reducing the absolute pressure in the enclosure about 0.1 pounds per square inch (psi).

53. The method of claim 43, wherein the step of introducing the first gas into the interpane space occurs at an absolute pressure of about 14 psi.
